(19) United States
(12) Patent Application Publication
(10) Pub. No.: US 2022/0288507 A1
(43) Pub. Date: Sep. 15, 2022

(54) ADSORPTION STRUCTURE, ADSORPTION APPARATUS, AND ADDITIVE MANUFACTURING METHOD FOR ADSORPTION STRUCTURE

(71) Applicant: MITSUBISHI HEAVY INDUSTRIES, LTD., Tokyo (JP)

(72) Inventors: Makoto INOMOTO, Tokyo (JP); Satsuki SHITOMOTO, Tokyo (JP); Ryuichi MATSUBARA, Tokyo (JP)

(21) Appl. No.: 17/677,445

(22) Filed: Feb. 22, 2022

(30) Foreign Application Priority Data
Mar. 9, 2021 (JP) 2021-037406

(51) Int. Cl. B01D 15/22; B33Y 10/00; B33Y 80/00; B33Y 40/10; B29C 64/314; B29C 64/124; B01D 15/18; B01D 53/04; B01J 20/02; B01J 20/26; B01J 20/28; B01J 20/30

(52) U.S. Cl. CPC B01D 15/22; B33Y 10/00; B33Y 80/00; B33Y 40/10; B29C 64/314; B29C 64/124; B01D 15/18; B01D 53/0407; B01J 20/0211; B01J 20/26; B01J 20/28026; B01J 20/3014; B01J 20/3085; B29K 2995/0068; B29L 2031/14

(57) ABSTRACT

An adsorption structure provided in a flow path through which a fluid flows includes a plurality of cells that are structural units and are arranged side by side in the flow path, and the cells each include an inorganic adsorbent material that adsorbs a component included in the fluid. The cells are cuboids, the plurality of cells are arranged to be in a lattice form in a plane orthogonal to a flow path direction in which the flow path extends, and are arranged to be alternately stacked in the flow path direction. The cells each have a collision portion with which a flow of the fluid changes in a direction intersecting with the flow path direction in which the flow path extends. The collision portion is a surface intersecting with the flow path direction.

### CROSS-REFERENCE TO RELATED APPLICATIONS

This application claims the benefit of priority to Japanese Patent Application Number 2021-037406 filed on Mar. 9, 2021. The entire contents of the above-identified application are hereby incorporated by reference.

### TECHNICAL FIELD

The present disclosure relates to an adsorption structure, an adsorption apparatus, and an additive manufacturing method for the adsorption structure.

### RELATED ART

An additive manufacturing method for a molded body or a three-dimensional network structure has been known in which a thermally molten three-dimensional additive manufacturing material including a porous metal complex and a thermoplastic resin is ejected and laminated (for example, see JP 2019-166655 A1.

### SUMMARY

Forming of an adsorption structure including an inorganic adsorbent material that adsorbs a component included in a fluid has been contemplated. The adsorption structure preferably has a large surface area for adsorbing the component included in the fluid. Unfortunately, the method disclosed in JP 2019-166655 A is an additive manufacturing method employing hot melt lamination, meaning that additive manufacturing of such an adsorption structure with a large surface area requires a support material and the like and thus is difficult to appropriately implement.

In view of the above, an object of the present disclosure is to provide an adsorption structure, an adsorption apparatus, and an additive manufacturing method for the adsorption structure with which the adsorption performance can be improved.

An adsorption structure provided in a flow path through which a fluid flows according to the present disclosure includes a plurality of cells that are structural units and are arranged side by side in the flow path, and each of the plurality of cells includes an inorganic adsorbent material that adsorbs a component included in the fluid.

An adsorption apparatus according to the present disclosure includes the adsorption structure described above; and a flow path in which the adsorption structure is accommodated and a fluid flows.

An additive manufacturing method for the adsorption structure described above according to the present disclosure includes: kneading the inorganic adsorbent material into an additive manufacturing liquid; and irradiating a liquid tank filled with the additive manufacturing liquid with curing light to form the adsorption structure by stereolithography.

Another additive manufacturing method for the adsorption structure described above according to the present disclosure includes: irradiating a liquid tank filled with an additive manufacturing liquid with curing light to form a precursor of the adsorption structure by stereolithography; submerging the precursor in a solvent including the inorganic adsorbent material; and drying the solvent to obtain the adsorption structure with a surface of the precursor provided with the inorganic adsorbent material.

According to the present disclosure, the adsorption performance can be improved.

### BRIEF DESCRIPTION OF DRAWINGS

The disclosure will be described with reference to the accompanying drawings, wherein like numbers reference like elements.

FIG. 1 is a perspective view illustrating an adsorption apparatus according to the present embodiment.

FIG. 2 is a cross-sectional view illustrating an adsorption structure according to the present embodiment.

FIG. 3 is a partially enlarged view of the adsorption structure.

FIG. 4 is a flowchart illustrating an example of an additive manufacturing method for the adsorption structure.

FIG. 5 is an explanatory diagram illustrating an example of an additive manufacturing method for the adsorption structure.

### DESCRIPTION OF EMBODIMENTS

Hereinafter, embodiments according to the present disclosure will be described in detail with reference to the drawings. Note that, the disclosure is not limited to the embodiments. In addition, components in the following embodiments include components that can be easily replaced by those skilled in the art or substantially the same components. Furthermore, the components described below can be appropriately combined, and when there are a plurality of embodiments, each embodiment can be combined.

### EMBODIMENT

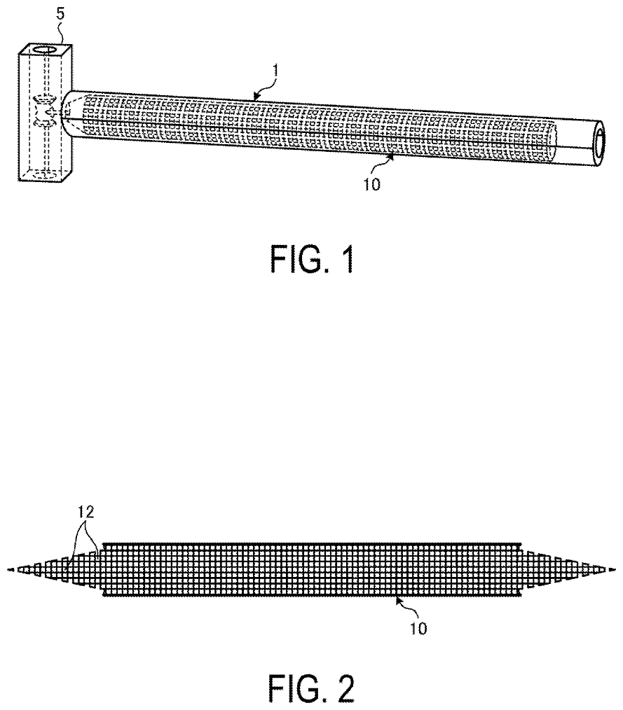

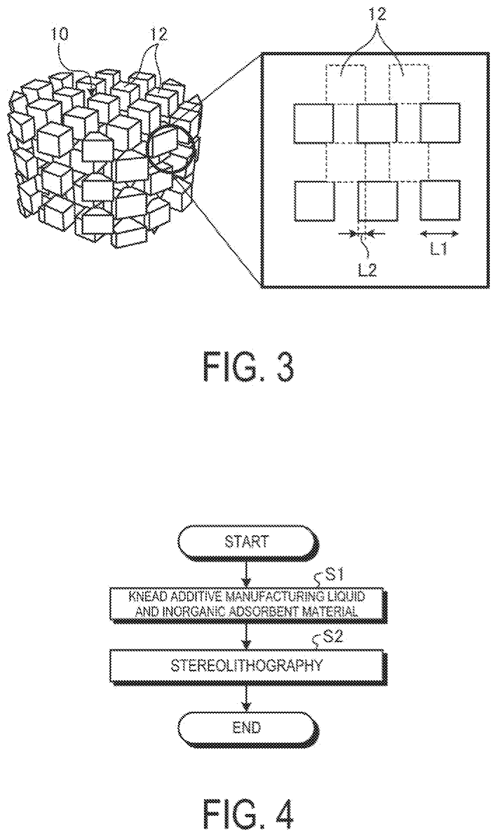

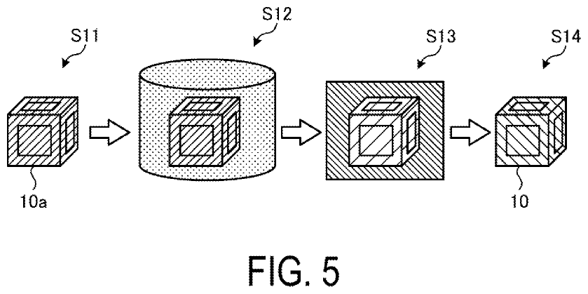

An adsorption apparatus 1 and an adsorption structure 10 according to the present embodiment are configured to adsorb a predetermined component included in a fluid. FIG. 1 is a perspective view illustrating the adsorption apparatus according to the present embodiment. FIG. 2 is a cross-sectional view illustrating the adsorption structure according to the present embodiment. FIG. 3 is a partially enlarged view of the adsorption structure. FIG. 4 is a flowchart illustrating an example of an additive manufacturing method for the adsorption structure. FIG. 5 is an explanatory diagram illustrating an example of an additive manufacturing method for the adsorption structure.

### Adsorption Apparatus

The adsorption apparatus 1 as illustrated in FIG. 1, in which a fluid flows, is applied to an analyzer, a remover, or the like, for example. Thus, the adsorption apparatus 1 is an apparatus for removing a predetermined component in the fluid and extracting a predetermined component in the fluid through adsorption. Note that the fluid may be a gas or a liquid. The adsorption apparatus 1 includes a flow path member 5 and the adsorption structure 10.

The flow path member 5 is a member having a flow path formed therein. The adsorption structure 10 is accommodated in the flow path. The flow path member 5 may have any shape and is not particularly limited as long as the flow path member 5 is a member in which a flow path is formed. Note that in the present embodiment, the flow path member 5 includes a pipe of a cylindrical shape extending in an axial direction, and the adsorption structure 10 is accommodated inside the pipe.

### Adsorption Structure

As illustrated in FIGS. 2 and 3, the adsorption structure 10 is formed in a shape complementary to the flow path with a hollow cylindrical shape. The adsorption structure 10 is formed by three-dimensional additive manufacturing using a stereolithography method. The adsorption structure 10 is formed by arranging a plurality of cells 12 side by side in the flow path. The plurality of cells 12 are arranged side by side along a flow path direction in which the flow path extends. The cells 12 are each a structural unit, and have a cuboid shape with each side having a length L1 in the present embodiment. Note that the cells 12 are not particularly limited to a cuboid shape, and may have a cuboid shape, a polyhedral shape, or a spherical shape.

Furthermore, the cells 12 include an inorganic adsorbent material that adsorbs a component included in the fluid. Examples of the inorganic adsorbent material include zeolites, titanium dioxide, silica gels, hydrated aluminum silicates, Zr, Sb, Bi, Mg—Al-based oxides, porous metal complexes (metal organic structures), and the like. The inorganic adsorbent material may be included at least on the surface of the cells 12. The content of the inorganic adsorbent material in the cells 12 is equal to or lower than 5 wt %, and is more preferably from 0.5 wt % to 1.5 wt %. Furthermore, when the inorganic adsorbent material is titanium dioxide, the content of the inorganic adsorbent material is equal to or lower than 1.5 wt %, and is more preferably approximately 1 wt %.

As illustrated in FIG. 3, the plurality of cells 12 are arranged in a lattice form in a plane orthogonal to the flow path direction in which the flow path extends. Furthermore, the plurality of cells 12 are arranged to be alternately stacked in the flow path direction. In other words, the adsorption structure 10 includes a plurality of cells 12 arranged to be in a lattice form in a stack of a plurality of stages. In spaces between the cells 12 in a stage on one side in the flow path direction, the cells 12 in a stage on the other side in the flow path direction are positioned. Thus, the cells 12 in the stage on one side and the cells 12 in the stage on the other side are arranged in a staggered layout (checkerboard layout) in the plane orthogonal to the flow path direction.

The cells 12 on one side in the flow path direction (solid lines) and the cells 12 on the other side in the flow path direction (dotted lines) partially overlap in the plane orthogonal to the flow path direction. Specifically, as illustrated in FIG. 3, parts of corner portions of a cell 12 on one side and corner portions of a cell 12 on the other side, each corresponding to a length L2, overlap in the direction orthogonal to the flow path direction.

The plurality of cells 12 configured in this manner are provided with collision portions with which the flow of the fluid is changed in a direction intersecting with the flow path direction. Specifically, the collision portion of the cell 12 is a surface intersecting with the flow path direction, and is a surface located on the upstream side in the flow path direction. This adsorption structure 10 has no through region as viewed in the flow path direction. Thus, the fluid flows in a meandering manner in the flow path direction, when passing through the adsorption structure 10.

When the fluid is a liquid, the surface of the cells 12 has a fine textured portion for imparting wettability. Because the textured portion has wettability, the surface area can be increased, and gas retention while the fluid flows can be suppressed.

The adsorption structure 10 of the present embodiment has a configuration in which the plurality of cells 12 with a cuboid shape stacked, but is not particularly limited to this configuration. The adsorption structure 10 may have the cells 12 having a honeycomb shape arranged side by side in the direction orthogonal to the flow path direction.

### Additive Manufacturing Method for Adsorption Structure

Next, an additive manufacturing method for the adsorption structure 10 will be described with reference to FIG. 4, The adsorption structure 10 is formed by a stereolithography method, and, for example, a stereolithography apparatus (SLA) method or a digital light processing (DLP) method is applied. Note that, in the additive manufacturing method for the adsorption structure 10 illustrated in FIG. 4, the adsorption structure 10 is additive manufactured using a general stereolithography apparatus.

In the additive manufacturing method for the adsorption structure 10 illustrated in FIG. 4, first, the inorganic adsorbent material is kneaded into an additive manufacturing liquid used for stereolithography (step S1). In step S1, the inorganic adsorbent material is kneaded into the additive manufacturing liquid with the kneading ratio of the inorganic adsorbent material being equal to or lower than 5 wt % as described above. Next, in the additive manufacturing method for the adsorption structure 10, a liquid tank is filled with the additive manufacturing liquid in which the inorganic adsorbent material has been kneaded, and then is irradiated with curing light, whereby the adsorption structure 10 is formed (step S2). Upon execution of step S2, the additive manufacturing method for the adsorption structure 10 ends. The adsorption structure 10 of the present embodiment is thus formed by stereolithography, whereby the structure with the plurality of cells 12 as illustrated in FIGS. 2 and 3 can be formed.

Next, another additive manufacturing method for the adsorption structure 10 will be described with reference to FIG. 5. Also in the additive manufacturing method illustrated in FIG. 5, a stereolithography method as in FIG. 4 is used.

In the additive manufacturing method for the adsorption structure 10 illustrated in FIG. 5, a liquid tank is filled with the additive manufacturing liquid, and then is irradiated with curing light, whereby a precursor 10a of the adsorption structure 10 is formed (step S11). In step S11, the precursor 10a is formed using a general stereolithography apparatus as in FIG. 4. Furthermore, in step S11, the fine textured portion for imparting wettability is formed on the surface of the precursor 10a. Next, in the additive manufacturing method for the adsorption structure 10, the precursor 10a is submerged in a liquid tank filled with a solvent including the inorganic adsorbent material (step S12). The processing in step S12 is performed by a dipping method for example. In step S12, because the fine textured portion is formed on the surface of the precursor 10a, the solvent can permeate the precursor 10a without forming any air reservoir in the solvent. Thereafter, in the additive manufacturing method for the adsorption structure 10, the precursor 10a is pulled out from the liquid tank, and the precursor 10a is placed in a drying furnace to be dried (step S13), whereby the adsorption structure 10 with the surface of the precursor 10a provided with the inorganic adsorbent material is obtained (step S14). Upon execution of step S14, the additive manufacturing method for the adsorption structure 10 ends.

The adsorption structure 10, the adsorption apparatus 1, and the additive manufacturing method for the adsorption structure 10 according to the embodiment described above are recognized as follows for example.

The adsorption structure 10 according to a first aspect is provided in a flow path through which a fluid flows and includes the plurality of cells 12 that are structural units and are arranged side by side in the flow path, and the cells 12 each include an inorganic adsorbent material that adsorbs a component included in the fluid.

With this configuration, the plurality of cells 12 including the inorganic adsorbent material are arranged side by side in the flow path to achieve a structure with a large surface area, whereby the adsorption performance can be improved.

According to a second aspect, the cells 12 each have a collision portion with which a flow of the fluid changes in a direction intersecting with a flow path direction in which the flow path extends.

With this configuration, the fluid can flow in a meandering manner with respect to the flow path direction to have more chances of coming into contact with the cells 12, whereby the adsorption performance can be further improved.

According to a third aspect, the cells 12 are cuboids, the plurality of cells 12 are arranged to be in a lattice form in a plane orthogonal to the flow path direction in which the flow path extends, and are arranged to be alternately stacked in the flow path direction, and the collision portion is a surface intersecting with the flow path direction.

With this configuration, the fluid flowing in the flow path direction can collide with the cells to have the flow changing in the direction intersecting with the flow path direction. Thus, the fluid can suitably meander, so that the fluid flow path can be longer, whereby the adsorption performance can be further improved.

As a fourth aspect, some cells 12, of the plurality of cells 12, on one side in the flow path direction and some cells 12, of the plurality of cells 12, on the other side in the flow path direction partially overlap in the plane orthogonal to the flow path direction.

With this configuration, discontinuity between the plurality of cells 12 can be suppressed, whereby the adsorption structure 10 can be formed with the plurality of cells 12 suitably stacked.

As a fifth aspect, the cells 12 each have a surface provided with a textured portion for imparting wettability.

With this configuration, when the fluid is a liquid, the fluid can flow without having any air reservoir formed therein. Furthermore, the cells 12 can have a large surface area, whereby the adsorption performance can be further improved.

According to a sixth aspect, a content of the inorganic adsorbent material in the cells 12 is equal to or lower than 5 wt %.

With this configuration, the content of the inorganic adsorbent material can be appropriate, whereby the adsorption structure 10 can be appropriately, formed.

According to a seventh aspect, when the inorganic adsorbent material is titanium dioxide, the content of the inorganic adsorbent material is equal to or lower than 1.5 wt %.

With this configuration, also when the inorganic adsorbent material is titanium dioxide, the adsorption structure 10 can be appropriately formed.

An adsorption apparatus 1 according to an eighth aspect includes the adsorption structure 10 described above and a flow path in which the adsorption structure 10 is accommodated and a fluid flows.

With this configuration, a predetermined component included in the fluid flowing in the flow path can be efficiently adsorbed by the adsorption structure 10.

An additive manufacturing method for the adsorption structure 10 described above according to a ninth aspect includes: step S1 of kneading the inorganic adsorbent material into an additive manufacturing liquid; and step S2 of irradiating a liquid tank filled with the additive manufacturing liquid with curing light to form the adsorption structure 10 by stereolithography.

With this configuration, the adsorption structure 10 in which the plurality of cells 12 are arranged side by side can be easily formed.

An additive manufacturing method for the adsorption structure 10 described above according to a tenth aspect includes: step S11 of irradiating a liquid tank filled with an additive manufacturing liquid with curing light to form a precursor 10a of the adsorption structure 10 by stereolithography; step S12 of submerging the precursor 10a in a solvent including the inorganic adsorbent material; and steps S13 and S14 of drying the solvent to obtain the adsorption structure 10 with a surface of the precursor 10a provided with the inorganic adsorbent material.

With this configuration, the inorganic adsorbent material does not need to be kneaded into an additive manufacturing material, whereby the precursor 10a can be appropriately formed. Furthermore, the inorganic adsorbent material can be provided on the surface of the precursor 10a, whereby the amount of the inorganic adsorbent material used can be reduced.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. An adsorption structure provided in a flow path through which a fluid flows, the adsorption structure comprising
a plurality of cells that are structural units and are arranged side by side in the flow path, wherein
each of the plurality of cells includes an inorganic adsorbent material that adsorbs a component included in the fluid.

2. The adsorption structure according to claim 1, wherein each of the plurality of cells includes a collision portion at which flow of the fluid changes in a direction intersecting with a flow path direction in which the flow path extends.

3. The adsorption structure according to claim 2, wherein
each of the plurality of cells is a cuboid,
the plurality of cells are arranged to be in a lattice form in a plane orthogonal to the flow path direction in which the flow path extends, and are arranged to be alternately stacked in the flow path direction, and
the collision portion is a surface intersecting with the flow path direction.

4. The adsorption structure according to claim 3, wherein some cells, of the plurality of cells, on one side in the flow path direction and some cells, of the plurality of cells, on the other side in the flow path direction partially overlap in the plane orthogonal to the flow path direction.

5. The adsorption structure according to claim 1, wherein each of the plurality of cells has a surface provided with a textured portion for imparting wettability.

6. The adsorption structure according to claim 1, wherein a content of the inorganic adsorbent material in the plurality of cells is equal to or lower than 5 wt %.

7. The adsorption structure according to claim 6, wherein when the inorganic adsorbent material is titanium dioxide, the content of the inorganic adsorbent material is equal to or lower than 1.5 wt %.

8. An adsorption apparatus comprising:
the adsorption structure according to claim 1; and
a flow path in which the adsorption structure is accommodated and through which a fluid flows.

9. An additive manufacturing method for the adsorption structure according to claim 1, the method comprising:
kneading the inorganic adsorbent material into an additive manufacturing liquid; and
irradiating a liquid tank filled with the additive manufacturing liquid with curing light to form the adsorption structure by stereolithography.

10. An additive manufacturing method for the adsorption structure according to claim 1, the method comprising:
irradiating a liquid tank filled with an additive manufacturing liquid with curing light to form a precursor of the adsorption structure by stereolithography;
submerging the precursor in a solvent including the inorganic adsorbent material; and
drying the solvent to obtain the adsorption structure with a surface of the precursor provided with the inorganic adsorbent material.
